(19) United States
(12) Patent Application Publication
(10) Pub. No.: US 2017/0366383 A1
(43) Pub. Date: Dec. 21, 2017

(54) Distributed NFV System Implementing Wired and Wireless Communications

(71) Applicants: Victor Demjanenko, Lockport, NY (US); Brower Alvin Dimond, Santa Barbara, CA (US)

(72) Inventors: Victor Demjanenko, Lockport, NY (US); Brower Alvin Dimond, Santa Barbara, CA (US)

(21) Appl. No.: 15/188,966

(22) Filed: Jun. 21, 2016

(51) Int. Cl. H04L 27/26; H04L 25/03

(52) U.S. Cl. CPC H04L 27/2628; H04L 25/03006; H04L 27/2602

(57) ABSTRACT

A system implementing a distributed communication system consisting of assignable common equipment using centrally located processors for performing data network services, bidirectional route-able communications link from common equipment to distributed equipment, and distributed equipment located near subscribers. Data network services are combination of wireline for use on a wired connection to a subscriber and wireless for use on radio connection to a subscriber. Data network services include protocol and modulation processing for the relevant wired or wireless communications standard. The distributed equipment used to send and receive signals to plurality of subscribers. The distributed equipment may support both wireline and wireless subscribers or may have separate subsystems for each.

This non-provisional patent application claims the benefit under 35 U.S.C Section 119(e) of U.S. Provisional Patent Application No. 62/231,019, filed on Jun. 22, 2015 which is incorporated herein by reference.

### FIELD OF THE INVENTION

This present invention relates to the application of Network Function Virtualization (NFV) techniques to communication systems. Existing and future standards for both wired and wireless communication systems can be structured to use the partitioning techniques and benefits of NFV. This specification covers techniques and methods that augment the NFV approach to deploying processing services for communications with subscribers. We also rely on an intimate knowledge of modulation methods used in modern wired and wireless communications systems. Those skilled in the art will understand and appreciate the methods that we teach.

### BACKGROUND OF THE INVENTION

To date, communications systems that provide wired and wireless services are typically implemented by substantial deployment of processing equipment to field locations where there is proximity to subscribers. This equipment is also often dedicated to a current communication standard and perhaps one (or possibly more) prior standards). Each new standard typically comes with a full rip-up and replacement. Network function virtualization is a concept to avoid some of these negative attributes. General purpose processors (with perhaps some specialized hardware) could be centrally located and utilized to perform a wide variety of communications standards. It is necessary to augment the NFV principles with one or more of the concepts described in this specification for deploying a well designed and efficient system,

### SUMMARY OF THE INVENTION

A system implementing a distributed communication system consisting of assignable common equipment using centrally located processors for performing data network services, bidirectional route-able communications link from common equipment to distributed equipment, and distributed equipment located near subscribers. Data network services are combination of wireline for use on a wired connection to a subscriber and wireless for use on radio connection to a subscriber. Data network services include protocol and modulation processing for the relevant wired or wireless communications standard. The distributed equipment used to send and receive signals to plurality of subscribers. The distributed equipment may support both wireline and wireless subscribers or may have separate subsystems for each.

### BRIEF DESCRIPTION OF THE DRAWINGS

FIG. 1 shows the decomposition of a mobile base station.

FIG. 2 shows the decomposition of a wired DSL system.

FIG. 3 shows the DSL transmitter processing.

FIG. 4 shows the cyclic extension, windowing and overlap of DMT symbols.

FIG. 5 shows a G.fast transmitter and subscriber loop interface.

FIG. 6 shows a first preferred partitioning for G.fast.

FIG. 7 shows a second preferred partitioning for G.fast.

FIG. 8 shows a third preferred partitioning for G.fast.

FIG. 9 shows the G,fast acknowledgment and re-transmission.

FIG. 10 shows a head end interface to a subscriber line.

FIG. 11 shows a head end interface to a communications link.

FIG. 12 shows a partitioned implementation of central equipment which performs vectoring for a group of subscriber lines.

FIG. 13 shows the retransmission processing delay sequence.

FIG. 14 shows a representation of a partitioned G.fast demonstration system.

FIG. 15 show a head end configuration with an Analog Front End (AFE) (shown as the analog-digital and digital-to-analog convectors and the hybrid electronics) for connections to the subscriber line and optical network connection to the server equipment.

FIG. 16 shows the subscriber's modem's AFE (shown as the analog-digital and digital-to-analog convectors and the hybrid electronics) and connection to a PC to process samples using G.fast algorithms and protocols.

FIG. 17 shows a conventional Digital Subscriber Loop Access Module (DSLAM) implementation for supporting xDSL technologies (ADSL and VDSL as shown here).

FIG. 18 shows a view of a preferred embodiment of a Virtual DSALM implementation enabled by the practice of this specification.

FIG. 19 shows another view of a preferred embodiment of a partitioned system using common centrally located equipment and distributed head-end equipment (Universal DPU or uDPU) capable of providing multiple service standards including wireless (microcell), wired (G.fast DPU), and WiFi or WiMax (business access) enabled by the practice of this specification.

FIG. 20 shows another view of a preferred embodiment of a partitioned system using multiple processors located at a central office (CO) datacenter and a communications network of fiber optic links to many field deployed universal DPU (uDPU) enabled by the practice of this specification.

FIG. 21 shows another view of a preferred embodiment showing a representative (blade) server comprised of multiple processors, a high speed fiber optical network, an optical wavelength multipexor, a single distributed universal DPU (uDPU) functioning as a virtual DSLAM (vDSLAM) had-end and copper subscriber lines connecting to subscriber homes.

### DETAILED DESCRIPTION OF THE INVENTION

We hereby incorporate by reference the following references:
1. ITU G.9700, “Fast access to subscriber terminals (G.fast)—Power spectral density specification”, ITU 2014.
2. ITU G.9701, “Fast Access to Subscriber Terminals (FAST)—Physical layer specification”, ITU 2014.
3. ITU Technical Paper, “Wireline broadband access networks and home networking”, ITU 2011.
4. ETSI NFV_White_Paper1, “Network Functions Virtualisation (NFV)”, ETSI 2012
5. ETSI NFV_White_Paper2, “Network Functions Virtualisation (NFV)”, ETSI 2013.
6. ETSI NFV_White_Paper3, “Network Functions Virtualisation (NFV)”, ETSI 2014.
7. ETSI GS NFV 001 v1.1.1, “Network Functions Virtualisation (NFV); Use Cases”, ETSI 2013.
8. Wikipedia “Orthogonal frequency-division multiplexing”.
9. Wikipedia “Fast Fourier transform”.

### 1. Introduction

G.fast refers to a new ITU standard for a digital subscriber line (DSL). G.fast (now also known as ITU standard G.9701) is the latest DSL standard designed to provide up to 1 Gbps aggregate date rate (125 MByte per second). It is specifically envisioned for short subscriber lines often in a “fiber to the neighborhood” configuration. Subscribers in this configuration share a common bundle of wiring for relatively short distances (up to 250 meters). Cross talk between subscribers is a know error effect which is compensated by “vectoring” in G.fast.

A preferred implementation for service providers is one that reduces the complexity of equipment deployed in the field. The concept of Network Function Virtualization (NFV) leads to an innovative solution where the G.fast processing is consolidated in a service center with a fiber optic network connection to rather minimal head-end equipment driving each small group of subscriber lines.

NFV is suggested as a means to efficiently re-use general purpose processing hardware (such as Intel x86 servers) to implement a variety of network router and database functions. Common x86 servers are multiprocessor, multicore system capable of performing a tremendous amount of computation. Consider this as one small cluster of modern day supercomputer used to run sophisticated weather, astrophysics, protein folding, or nuclear weapon simulations.

As applied to our distributed G.fast system, the centrally located multicore x86 server is handling several G.fast subscriber lines with the required cross-line vectoring. Analog samples are sent to, and received from, head-end equipment located remotely. Our recommendation is to use a fiber optic network connection configured to support high speed optical Ethernet. Of course any other high speed link could be used with similar performance and capabilities.

The head-end equipment in this configuration consists of a G.fast DSL analog front end (AFE), an analog to digital convertor and a digital to analog convertor for each subscriber line. For convenience and cost, a head-end can be designed to accommodate 16 subscriber lines in equipment fully populated or perhaps populated in two or four line sets. Providing service to a small number of subscribers within a cluster of homes is now less costly. The head end equipment does not need to be fully populated with all 16 analog circuits and signal processing/networking gear.

### 1.2 G.Fast Symbol Structure

G.fast is the latest Digital Subscriber Loop (DSL) standard developed over the past 15 years. The modulation is based on a plurality of carriers each modulating a QAM constellation. For efficiency, the implementation uses an Inverse Fast Fourier Transform (IFFT) to convert a complex representation to a set of real time-ordered samples. The general name for this modulation technique is OFDM (Orthogonal Frequency Domain Multiplexing.

(next 3 paragraphs from Wikipedia)

Orthogonal frequency-division multiplexing (OFDM) is a method of encoding digital data on multiple carrier frequencies. OFDM has developed into a popular scheme for wideband digital communication, used in applications such as digital television and audio broadcasting, DSL Internet access, wireless networks, powerline networks, and 4G mobile communications.

OFDM is a frequency-division multiplexing (FDM) scheme used as a digital multi-carrier modulation method. A large number of closely spaced orthogonal sub-carrier signals are used to carry data[1] on several parallel data streams or channels. Each sub-carrier is modulated with a conventional modulation scheme (such as quadrature amplitude modulation or phase-shift keying) at a low symbol rate, maintaining total data rates similar to conventional single-carrier modulation schemes in the same bandwidth.

The primary advantage of OFDM over single-carrier schemes is its ability to cope with severe channel conditions (for example, attenuation of high frequencies in a long copper wire, narrowband interference and frequency-selective fading due to multipath) without complex equalization filters. Channel equalization is simplified because OFDM may be viewed as using many slowly modulated narrowband signals rather than one rapidly modulated wideband signal. The low symbol rate makes the use of a guard interval between symbols affordable, making it possible to eliminate intersymbol interference (ISI) and utilize echoes and time-spreading (on analogue TV these are visible as ghosting and blurring, respectively) to achieve a diversity gain, i.e. a signal-to-noise ratio improvement. This mechanism also facilitates the design of single frequency networks (SFNs), where several adjacent transmitters send the same signal simultaneously at the same frequency, as the signals from multiple distant transmitters may be combined constructively, rather than interfering as would typically occur in a traditional single-carrier system.

Table 1 describes the number of carriers, carrier width and nominal cyclic prefix for each of the common DSL implementations (ADSL, VDSL, VDSLs and G.fast low (106) and high (212) profiles). From these three parameters, the FFT size (double the number of carriers) and sample rate are directly derived. The FFT rate represents the number of IFFT's performed per second. This is not simply based on the sample rate and FFT size but rather it includes the repeated samples included for the cyclic prefix/suffix. A cyclic prefix is used to reduce intersymbol interference (ISI) between successive IFFT modulated signal segments. The implementation of the cyclic prefix simply prefixes a set of samples for a symbol with the last Lcp samples of the set where the length of the prefix, Lcp samples, is based on the expected maximum duration of signal dispersion/spreading due to multipath reflections and other electrical signal transmission issues.

TABLE 1
Carriers, carrier width and nominal cyclic prefix for DSL Standards.

| | | | Sample | | | |
|---|---|---|---|---|---|---|
| | | Width | Rate | | Cyclic | FFT Rate |
| | Carriers | (KHz) | (MHz) | FFT Size | Prefix | (per sec.) |
| ADSL | 256 | 4.3125 | 2.208 | 512 | 40 | 40000 |
| VDSL | 2048 | 4.3125 | 17.664 | 4096 | 320 | 40000 |
| VDSL2 | 4096 | 4.3125 | 35.328 | 8192 | 640 | 40000 |
| G.fast - L | 2048 | 51.75 | 211.968 | 4096 | 320 | 480000 |
| G.fast - H | 4096 | 51.75 | 423.936 | 8192 | 640 | 480000 |

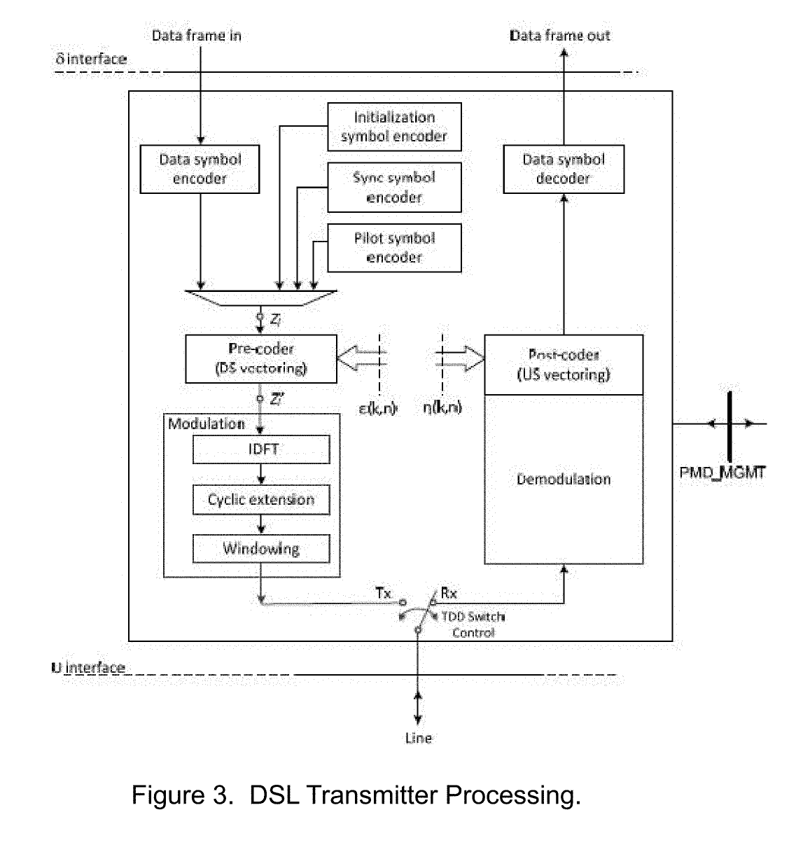

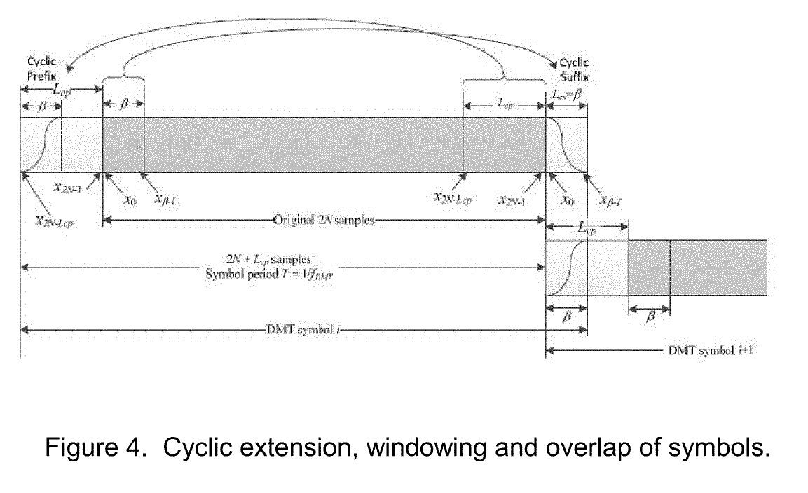

The sequence of processing in a transmitter is shown in FIG. 3. The actual implementation of the transmitter shows an additional level of processing referred to as windowing. Windowing is used for spectral shaping. Windowing is in addition to cyclic extension but is similarly derived. Windowing uses the first β samples of the IFFT symbol after the end of the samples for the symbol as a sample suffix. These samples are ADDED to the first β samples of the next symbol's cyclic prefix as illustrated by FIG. 4.

According to the G.fast specification, all lines in a vectoring group use the same Lcp. Note that only when Lcp is set to 320 does the FFT rate become 48,000 per second. In other words, the 320 value of Lcp should be considered as nominal. The value of β (either 64 or 128) in samples is selected at G.fast initialization by communications between the peer FTU.

### 1.2. G.Fast Analog Parameters

Precise analog parameters are not fully spelled out in the G.fast specification. Rather important limits such as maximum transmit power (+4 dBm) and frequency power masks. Describe constellation size, bits resolution required for DAC and for ADC directions including provision for a programmable, adjustable, adaptable AFE receive gain.

This patent application describes inventions related to several aspects of the underlying motivation, concepts, technology, implementation and uniqueness. These are the following:

1) A partitioned architecture used for both wireless and wireline partitioned systems. This can be implemented on a multicore x86 server performing all signal processing and protocol handling. A benefit is simplified head-end equipment located in the field which can more easily accommodate multiple communication standards that either already exist or future standards.

We recommend fiber optic communications for low latency but can be implemented on other fast networks.

2) With a simple design of head-end equipment, there are greater opportunities for re-use. This would supports incremental growth of the network as more subscribers are added. There would be a low cost of just idle head-end equipment for subscribers in new areasa of deployment. A simple design also leads to lower or lowest power consumption and higher MTBF (mean time between failure).
3) Our partitioned system supports bandwidth control and varying customer subscription levels. We support subscribers for varying service levels (maximum bandwidth). We anticipate the need for changing bandwidth requirements over time. Until necessary, we advocate utilizing less spectrum on a per channel basis while leaving duty cycle mostly dictated by maximum bandwidth channels.
4) In support of bandwidth control policies, there are several novel techniques applicable for partitioned systems. In particular for systems that use IFFT/FFT based modulation/demodulation, we exploit properties of frequency/time domain representations. One such approach sends fewer samples by skipping every other sample for use of half of the available spectrum. An extension to quarter spectrum would skip three samples out of four.
5) Additional bandwidth reduction results from remotely creating the cyclic prefix/suffix. From the inverse FFT real samples, the cyclic prefix can be implemented in the head-end AFE if it saves the first samples to repeat as the prefix. This reduces bandwidth in server to head-end direction.
6) In order to extend the range between head-end and the shared centralized processing server, communication latency needs to be considered. Use of fiber optic communication is ideal because of its high speed and low latency. Further optimization over any kind of network link would possibly use delivery of AFE samples in channel multiplex order and samples muxing/demuxing as they arrive without waiting for full frames. Of course this would be in specialized head-end equipment.
7) Sample loading tables are suggested for implementing muxing tables to control #bits per sample, #bit shift for sample, #skipped samples for each channel as well as cyclic prefix, cyclic suffix (windowing) parameters. Start/end of symbol sample indication(s).
8) Similar functions can also be applied to the upstream sampling. Head-end equipment should support alternate decimation rates and perhaps a selection of switched capacitor filters.

These aspects are described in the following sections.

### 2. Partitioned Architecture

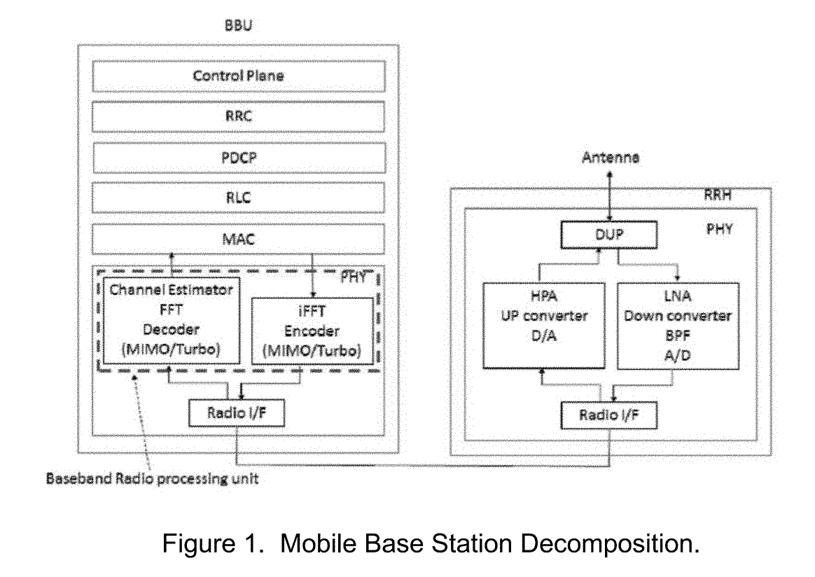

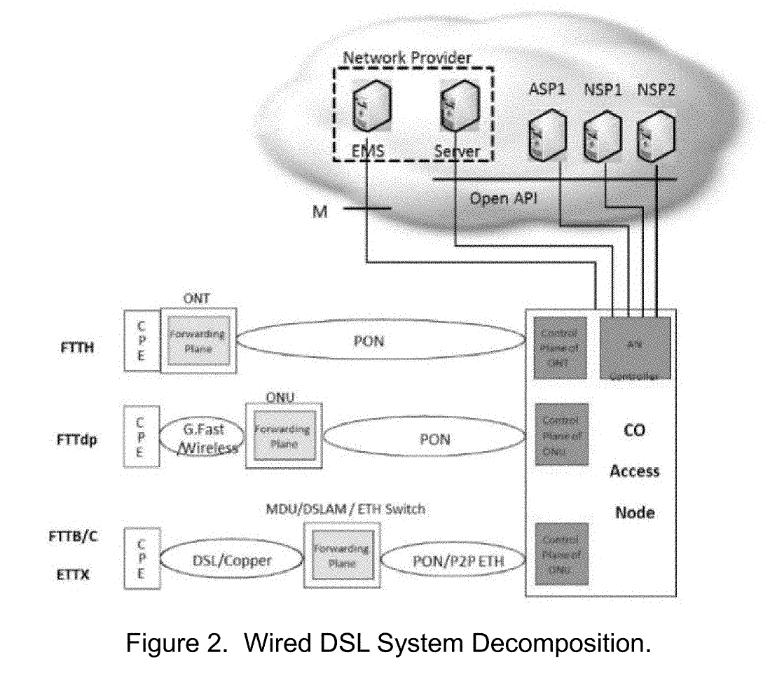

Network Functions Virtualization (NFV) is an industry concept of centrally locating general purpose processors to perform a variety of software services such as routing, residential gateways, video set top box, processing and even handling of modulations for wireless and wired connections. ETSI document GS NFV 001 V1.1.1 illustrates several representative use cases. Case 6 (FIG. 1) specifically suggests the virtualization of a Mobile Base Station. Case 9 (FIG. 2) addresses Fixed Access Network Function Virtualization which covers various ADSL, VDSL and fiber technologies.

There are many motivating reasons for NFV. And there are many easier use cases for NFV. Specifically addressed by this filing are the more challenging applications for NFV. Both wired and wireless access methods/standards can be supported by equipment and software as will be described. While the general concept suggests this support is possible, it does not explore and exploit the details of each that are amenable to a successful implementation.

FIG. 1 is suggests a partitioning of a wireless base station into a Base Band Radio Unit (BBU) and an RF head end. The suggested interconnection is at the radio I/F interface carrying a base band modulated signal. The full baseband modulation (up to and including the FFT/IFFT) is handled in a centrally located Base Band Radio Unit (BBU). The head-end equipment has the actual RF modulator with power amps, antenna and up/down conversion from/to baseband. The BBU may be located in a relatively regional data processing center while the head-end is distributed in the physical environment nearby wireless subscribers. Such wireless base station may implement any existing wireless radio standard (such as but not limited to, GSM 3G or 4G, LTE, WiFi, WiMax) or any new wireless standard to be developed.

This architecture can be improved upon. A BBU has conventionally been implemented in special purpose hardware. However, x86 server processors have become very successful in implementing complex operations such as signal processing. Optimized software implementation of IFFT and FFT operations are commonly available on x86 servers through the use of software libraries. As technologies and standards evolve, software on an x86 can easily be upgraded while there could be significant limits to upgrading the function of a BBU based on special purpose hardware.

As more wireless devices are deployed and greater wireless speeds are demanded, more and more radio front ends would be needed. Cells are often made smaller and smaller to accommodate the greater density of devices and their insatiable bandwidth. Micro-cells and Femto-cells are common names for such approaches. The concept of small cells will be returned to after the discussion of a NFV system to handle wireline access.

For the purposes of wireline access, the focus will be on the latest DSL standard, G.fast which is now known as G.9700/G.9701 Fast Access to Subscriber Terminals. While it is conceivable to accommodate a variety of ADSL, VDSL, VDSL 2 and G.fast links in a similar system, the benefits of a homogeneous system could not be as readily exploited. One of the key differences is the length of subscriber loop that each technology supports. As the speeds are raised, the loop length is reduced. Maximum G.fast loop length is 250 m compared to 500 m for VDSL 2, 1.5 Km for VDSL and 4 Km for ADSL. The practical implication of this widely varying maximum loop length is that a partitioned architecture would require the field deployed head-end to be no more than 250 m from a group of subscribers. For maximum performance of the G.fast modulation, vectoring must be used across all lines in the same binder (cable). Dissimilar modulations such as ADSL and VDSL will negatively impact G.fast performance because vectoring with these is essentially not realistic.

AT&T offers wireline access under the U-verse trademark without a reference to a specific technology of fiber, ADSL or VDSL. A homogenous deployment of the fastest wireline technology, G.fast, would enable a service provider such as AT&T to upgrade its field equipment once and then selectively upgrade or permit greater subscriber speeds as customer needs advance. Since G.fast can be throttled to lower operating speeds (limited by subscriber choice), a homogeneous system based totally on G.fast can offer the highest performance with full vectoring for enabled subscribers while still supporting the more limited connections.

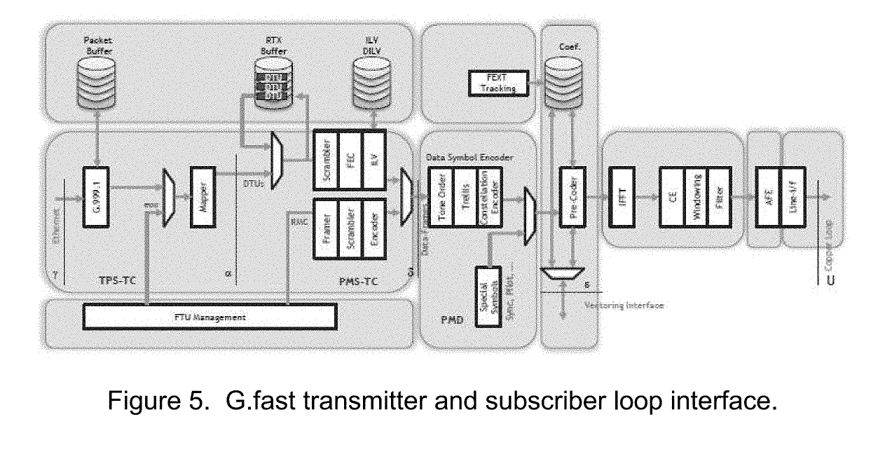

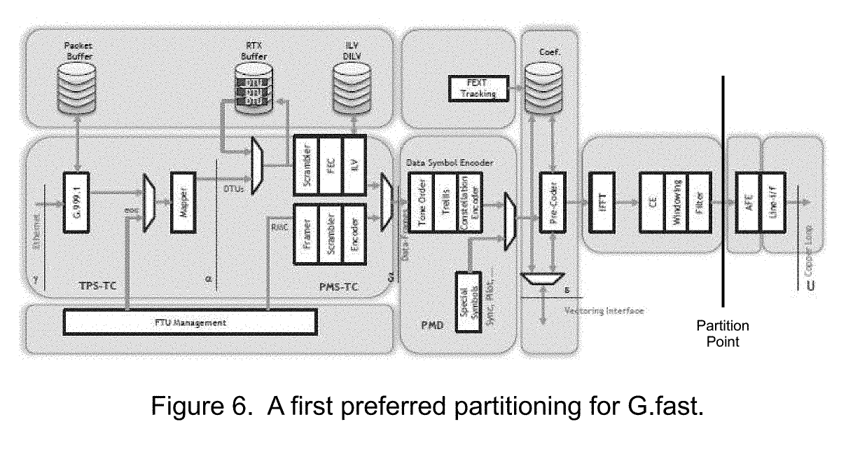

A partitioned G.fast system would be similar to the BBU distributed radio. FIG. 5 shows a suggested G.fast transmitter and subscriber loop interface. A preferred division could be at the interface between the filter and the AFE on the right as shown in FIG. 6. In this case, the centralized G.fast modulator/demodulator would perform all of the sample processing and send/receive analog samples to/from the AFE (analog front end). The AFE has the circuits necessary to facilitate rendering the modulated G.fast signal onto the subscriber's loop at the permitted power level as by ITU G.9700.

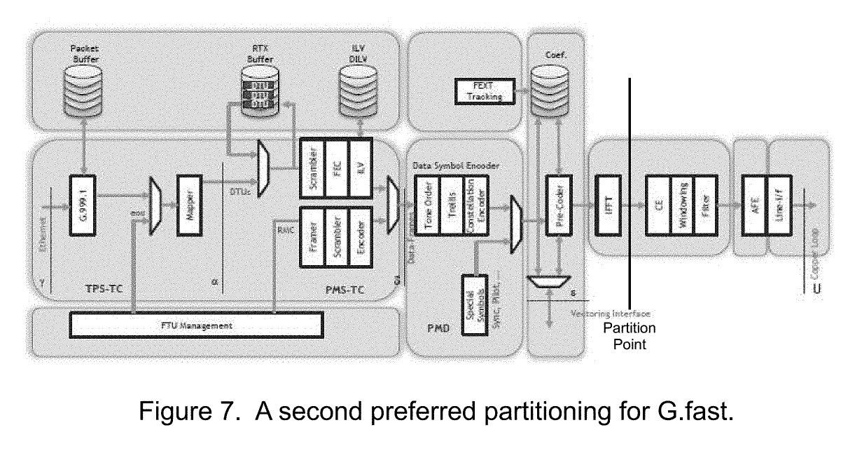

An alternative division could be between the IFFT and the CE (Cyclic extension) as shown in FIG. 7. Since the CE, Windowing and filtering perform simple operation on the IFFT sample outputs (such as copying and adding), a slightly reduced bandwidth is possible with this division (as compared to the prior division between the filter and the AFE.

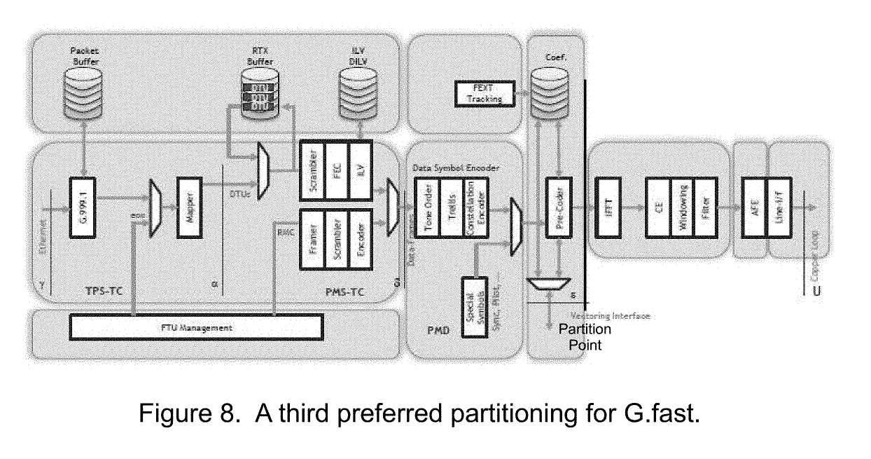

Another alternative division could be between the vectoring and the IFFT processes as shown in FIG. 8. This would also have similar reduced bandwidth. FFT and IFFT operations are well suited for high speed hardware implementation and could be performed in the distributed equipment. Raising the division one layer higher to include the vectoring in the distributed equipment is also possible (and possibly desirable). It could be desirable as the distributed equipment would be connected to all subscriber loops in a given bundle over which vectoring is required. Hence it would naturally have all the subscriber signal information necessary to fully perform the vectoring cross talk remediation operations. This degree of functionality does however require more “smarts” in the distributed G.fast AFE than may perhaps be advisable. From the perspective of upgradeability, less complex functionality in the distributed G.fast AFE is preferred. For these reasons, we prefer a division or partitioning anywhere between the vectoring and the AFE functions.

Co-location of the distributed G.fast AFE and the wireless head-end is considered next. Since the distributed G.fast AFE is as a maximum of 250 m from a group of subscribers, a collated cell would cover a similar group of subscribers. Some subscribers may be pure wireline, other pure wireless, but most will probably be using both wired and wireless services. (It should be noted that many wireless subscribers will automatically use the home's WiFi wireless services when available. However, there are many services which only work on the wireless network such as voice calls and text messages.) Common equipment to perform functions for wireline and wireless access can represent additional cost savings to a service provider.

The communications link can be implemented over a wide variety of media. In a preferred embodiment, communication links with data transfer high-speed and low latency would be desirable. This would be especially true for meeting tightly constrained re-transmission periods in specification such as G.fast. For this reason would anticipate that optical networks would most likely be used in this application. It is possible that with the advent of 10G wired Ethernet that some wired network may also be used. The communication links that would be most useful in a preferred embodiment supporting Network Function Virtualization (NFV) may be either routed (as in Layer 3) or at least switchable (as in Layer 2) as opposed to directly connected point-to-point links. It should be noted that virtual LANs can also be considered as a Layer 2 switch supported capability. Point-to-point links may be used in an alternate preferred embodiment where NFV principals are not applied.

Optical networks also support a multiplexing technique using different light wavelengths (commonly referred to as lambda). Up to 40 different lambda are already being used. Since this is at the physical layer, this would correspond to a Layer 1 switching or multiplexing or routing technique.

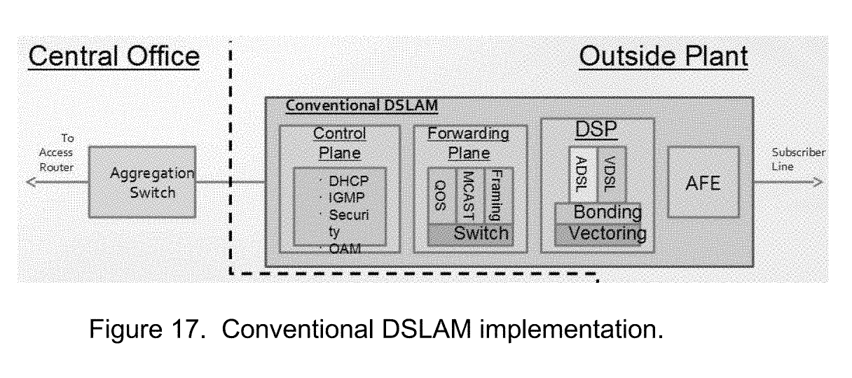

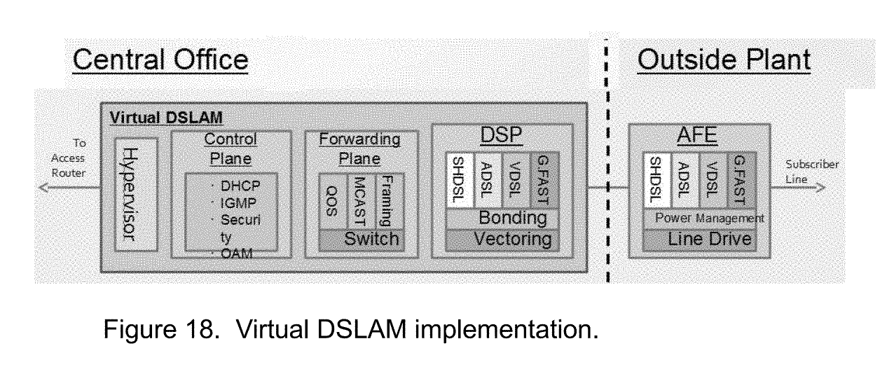

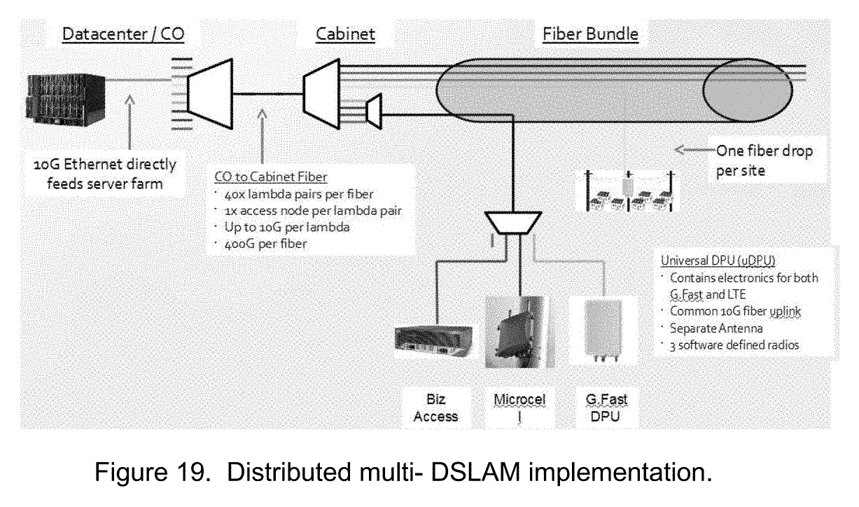

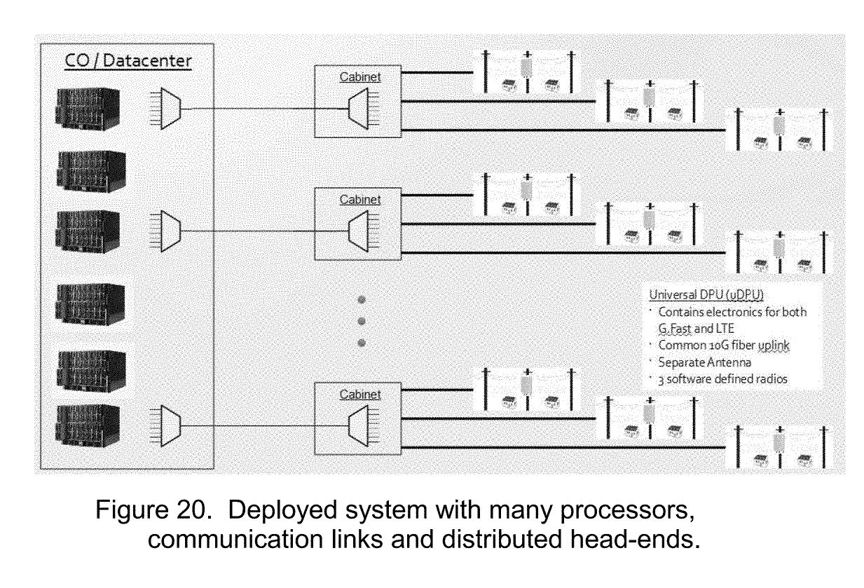

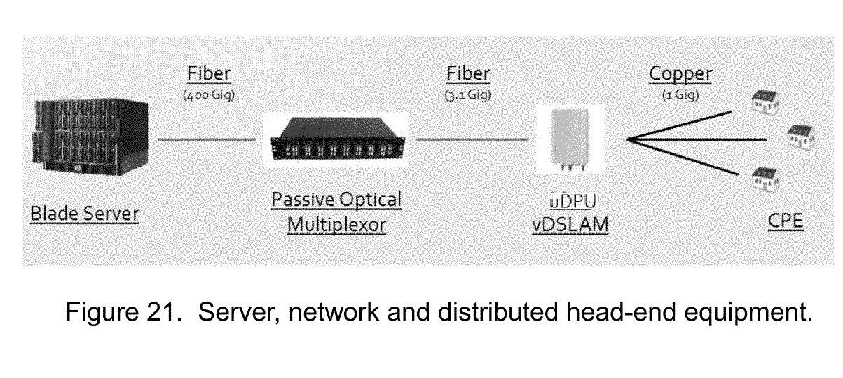

As a contrast to one of our preferred embodiment, FIG. 17 shows a conventional Digital Subscriber Loop Access Module (DSLAM) implementation for supporting xDSL technologies (ADSL and VDSL as shown here). FIGS. 18, 19, 20 and 21 show various aspects of one of our preferred embodiments. These include a Virtual DSALM implementation, a partitioned system using common centrally located equipment and distributed head-end equipment (Universal DPU or uDPU) capable of providing multiple service standards including wireless (microcell), wired (G.fast DPU), and WiFi or WiMax (business access) and a partitioned system using multiple processors located at a central office (CO) datacenter and a communications network of fiber optic links to many field deployed universal DPU (uDPU) all enabled by the practice of this specification. FIG. 21 shows a representative (blade) server comprised of multiple processors, a high speed fiber optical network, an optical wavelength multipexor, a single distributed universal DPU (uDPU) functioning as a virtual DSLAM (vDSLAM) head-end and copper subscriber lines connecting to subscriber homes.

In this specification, we will use the term “route-able” to refer to any method of Layer 3, Layer 2 or Layer 1, routing, switching, virtual LANs or multiplexing as applied to the communications link.

The common equipment would use centrally located processors for performing the respective wireline or wireless data network services, a (route-able) communications link from the common equipment to the distributed equipment and the distributed equipment located near subscribers.

The data network services are wireline for use on a wired connection to a subscriber.

The data network services are wireless for use on radio connection to a subscriber. The data network services are a combination of both wired and wireless.

The data network service is comprised of protocol and modulation processing.

The processors would be comprised of general purpose processors.

The general purpose processors would be based on x86 processors (such as those made by Intel or AMD)

The general purpose processors would be based on ARM processors.

The processors would be comprised of multicore processors.

The route-able communications link would be comprised of a fast packet network.

The fast packet network would be low latency.

The fast packet network would be electrical (such as wired Ethernet).

The fast packet network would be optical (such as optical Ethernet or optical GPON).

The route-able communications link facilitates a fast time division multiplexed sample delivery system.

The distributed equipment would be used as an element to provide wireline data network services.

The distributed equipment comprises a head-end device to drive signals onto each subscriber line.

The distributed equipment comprises a multiplicity of head-end devices to drive signals onto multiple subscriber lines.

The distributed equipment comprises a head-end device to receive signals from each subscriber line.

The distributed equipment comprises a multiplicity of head-end devices to receive signals from multiple subscriber lines.

The wireline data network services implemented by the distributed equipment would include a signal driver for a subscriber line.

The wireline data network services implemented by the distributed equipment would include a G.fast analog front end.

The wireline data network services implemented by the distributed equipment would include a DSL analog front end.

The distributed equipment would be used as an element to provide wireless data network services.

The wireless data network services implemented by the distributed equipment would include an RF head-end.

The distributed equipment would be used as an element to provide both wireline and wireless data network services.

The common equipment would be used as an element to provide wireline data network services.

The common equipment would be used as an element to provide wireless data network services.

The common equipment would be used as an element to provide both wireline and wireless data network services.

The centrally located processors used as the common equipment would likely be implemented on general purpose processors such as Intel/AMD x86 multicore servers and/or ARM multicore servers. These processors may run various different applications depending on the current application load. Some may be running the G.fast modulation/demodulation services. Others may be running the wireless modulations. And yet others may be running other NFV functions.

Alternatively the centrally located processors may actually be dedicated to specific functions based on subscriber commitments. In an example configuration, up to 16 subscriber lines are serviced by one distributed G.fast AFE (in a uDPU). Of these 16 subscriber lines, 2 are full unrestricted bandwidth, 2 are half bandwidth, 4 are quarter bandwidth (or less) and the remaining 8 are not subscribing to digital wireline data services. Assuming that one processor core is required for the full bandwidth, the above example suggests that 4 processor cores are required to perform the processing (according to the set of current subscriber requirements). These processor resources would be allocated by a management system with cross subscriber data exchanges specified for the implementation of vectoring operations. A salient property of this type of system is that when the subscriber requirements change, the change is implemented by a management system with no physical changes to the deployed hardware.

A service provider can better plan usage of it's infrastructure by assigning subscribers to sets sharing each type of compatible resources including but not limited to processing performed by centrally located (general purpose) servers (possibly x86 or ARM or DSP based), (route-able) communications links and distributed equipment (uDPU) located near subscribers.

A service provider can better plan usage of it's infrastructure by assigning subscribers to sets for each type of compatible resources including but not limited to centrally located processors for performing respective wireline or wireless data network services, a communications link from common equipment to distributed equipment and distributed equipment located near subscribers.

Some sets of subscribers for a service provider's infrastructure resources are naturally formed by their geographic location. As an example this would include those subscribes sharing a wired cable bundle delivering their subscriber lines to their residence. Similarly wireless (LTE and next generation) subscribers in physical proximity to each other would be naturally grouped. These sets of subscribers would likely share some of the service provider's communications link (but perhaps not all) and would share distributed equipment (uDPU) for wired and wireless access.

The service provider's creation of sets of subscribers formed to utilize common servers located at their (service providers) data centers may be considerably more varied. They can be grouped in such as way as to (nearly) full load compute resources as an example. Protocol processing may be performed on specific servers which may be well suited for that application. Protocol processing may be assisted by specific hardware accelerators to perform packet fragmentation, routing (layer 3), encryption, support of virtual LANs (a layer 2 switching mechanism). Other processors may be well suited for computational aspects of performing the modulation (and demodulation). (It should be noted that for the purposes of this specification the term “modulation” should be interpreted as bidirectional meaning both modulation and demodulation.) Use of specialized hardware for FFT/IFFT acceleration may also be shared and assigned in various subscriber sets. The specialized hardware may consist of digital signal processors (DSPs) or FPGAs or other customized hardware to perform intensive aspects of the modulations. Vectoring is yet another computational intensive aspect that may be assigned to yet different subscriber sets. By the nature of vectoring, the subscriber set for this purpose would be based on physical aspects such as shared cable binders or a nearby wireless head-end location.

Sets of subscriber requirements are serviced by specifying specific processing resources to perform an intended or dedicated function.

A set of subscriber requirements are serviced by specifying a group of processing resources to function together to provide wireline data network service.

A set of subscriber requirements are serviced by specifying a group of processing resources to function together to provide digital subscriber line/loop (DSL) service.

The set of subscriber requirements are grouped by customers who share distributed equipment.

The set of subscriber requirements are grouped by customers who share a binder cable carrying their subscriber line.

The group of processing resources consist of one or more processors.

The group of processing resources consist of one or more general purpose processors.

The group of processing resources consist of one or more multicore processors.

The group of processing resources consist of one or more specialized processors.

The group of processing resources consist of one or more specialized processors using one or more digital signal processors.

The group of processing resources consist of one or more specialized processors using one or more FPGAs for algorithm acceleration.

The group of processing resources consist of one or more specialized processors using one or more specialized logic circuits for algorithm acceleration.

The group of processing resources function together to provide wireline data network service.

The group of processing resources function together to provide DSL service.

The group of processing resources function together to provide G.fast DSL service and performs vectoring operations.

The group of processing resources function together implementing vectoring operations.

The interconnection between the centrally located common equipment and the field deployed distributed equipment would preferentially use a high speed data link. This data link should be low latency. Latency is a concern because of implementation requirements to meet various time-based performance specifications in wireline and wireless standards.

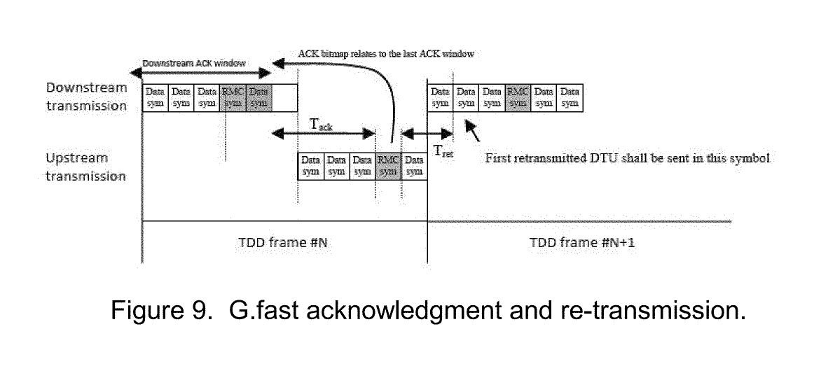

G.fast as an example has a re-transmission requirements (FIG. 9) for acknowledge, Tack, and for retransmission, Tret, of 400 usec for the service provider (FTU-C) and 300 usec for the subscriber's equipment (FTU-R). By separating the G.fast AFE from the processing equipment (at the central location), the additional effect of signal propagation time needs to be considered. This is on-top of any time required to construct and deconstruct packets of samples (data) to be transmitted and received over the high-speed data link.

There are many elements that comprise the actual delay of the transmit protocol handling, modulation, conversion to samples, presenting samples to the subscriber line, acquiring samples from the subscriber line, conversion of samples to the demodulation format, demodulation and receive protocol handling. By using centrally located equipment for any of this processing, and then communicating to the distributed equipment, the delay for any sort of round-trip or one-way operation is going to be increased. The delay increase is due to the physical property of the speed of light in a vacuum, c, being nearly 300,000 km per second (actual speed is 299,792,458 m/s). Constrained in a silica glass fiber optic media, the speed is 31% slower. (A common engineering approximation is 8 inches per second.) Electrical signal propagation is similarly reduced in speed and in generally has a greater speed reduction than light in optical fiber. Cat5e cabling propagates signals at about 36% slower than the speed of light in a vacuum.

The increase in signal speed by using fiber optic is less by a significant enough amount. This increase in speed helps any distributed implementation meet a turn-around time delay requirement (such as Tret and Tack in G.fast). If the centrally located equipment was 10 km (6 miles) from its distributed equipment, the additional delay would be approximately 48 usec one way or 96 usec round trip. Of course this delay is significant relative to the 400 usec Tret/Tack times of G.fast. And this delay is less by using optical rather than electrical signal propagation for an identical distance.

The common equipment performs the wireline or wireless data network service (protocol and modulations), uses a bidirectional (route-able) communications link between the common equipment and the distributed equipment (located near subscribers), and then uses the distributed equipment to send and receive signals to plurality of subscribers.

The data network services are wireline for use on a wired connection to plurality of subscriber.

The data network services are wireless for use on radio connection to plurality of subscriber.

The data network services are a combination of both wired and wireless.

The data network service is comprised of protocol and modulation processing.

The protocol and modulation performed jointly by the common and distributed equipment has one or more one-way timing requirements.

The protocol and modulation performed jointly by the common and distributed equipment has one or more round trip (two-way) timing requirements.

The route-able communications link used between the common and distributed equipment is low latency and high speed.

The route-able communications link uses optical transmission to obtain greater distance between common and distributed equipment.

The route-able communications link uses fiber optical media to obtain greater distance between common and distributed equipment.

The route-able communications link uses optical transmission to obtain reduced transmission time between common and distributed equipment.

The route-able communications link uses fiber optical media to obtain reduced transmission time between common and distributed equipment.

The distributed equipment would be used as an element to provide both wireline and wireless data network services.

The common and distributed equipment would provide wireline data network services.

The common and distributed equipment would provide wireless data network services.

The common and distributed equipment would provide both wireline and wireless data network services.

### 3. Simplified Equipment Design

The distributed equipment suggested in this application for either DSL wireline services or wireless services can be considered as a virtual DSLAM (Digital Subscriber Line Access Multiplexer) which hereby referenced as a vDSLAM (virtual Digital Subscriber Line Access Multiplexer). This equipment is considered virtual as only the line interface (for wireline services) or the radio head-end (for wireless services) is located remotely. The majority of the signal and data processing is centrally located and operating on a reconfigurable set of general purpose processors. There are several direct benefits to this organization. The equipment deployed in the field is less greatly simplified and consumes less power. This makes the distributed equipment less costly and more reliable. Reliability is inversely related to the complexity of a device and its power consumption which is related to heat stress and component life. The more limited distributed equipment is also generally easier to protect against various environmental stress factors such as extreme heat and lighting. Also, the more delicate high speed processing equipment which is now more centralized is easier to protect and house in an environmentally secured facility. This can further reduce costs for the deployed wireline and wireless services.

The common equipment would use centrally located processors for performing the respective wireline or wireless data network services and distributed equipment.

The data network services are wireline for use on a wired connection to a subscriber.

The data network services are wireless for use on radio connection to a subscriber.

The data network services are a combination of both wired and wireless.

The data network service is comprised of protocol and modulation processing.

The common equipment would be located in an environmentally friendly facility housing one or more centrally located processors.

An environmentally friendly facility consist of one or more favorable attributes.

Favorable attributes include any single or combination of the following: controlled temperature, controlled humidity, clean power (no under or over voltage occurrences), backup power, isolation from hazardous voltages (such as lightning), limited access (to authorized personnel), protection from accidental damage.

The distributed equipment is reduced in functionality to limit its damage in by an environmentally unfriendly field deployed location.

An environmentally unfriendly location consist of one or more unfavorable attributes.

Unfavorable attributes include any single or combination of the following: excess temperature, excess humidity, unclean power (possible under or over voltage occurrences), subject to power loss, exposure to hazardous voltages (such as lightning), unlimited access (by unauthorized personnel), exposure to accidental damage.

The distributed equipment is reduced in functionality to increase its reliability or mean time to failure (MTBF).

The distributed equipment would be used as an element to provide wireline data network services.

The distributed equipment would be used as an element to provide wireless data network services.

The distributed equipment would be used as an element to provide both wireline and wireless data network services.

The common equipment would be used as an element to provide wireline data network services.

The common equipment would be used as an element to provide wireless data network services.

The common equipment would be used as an element to provide both wireline and wireless data network services.

The common and distributed equipment would provide wireline data network services.

The common and distributed equipment would provide wireless data network services.

The common and distributed equipment would provide both wireline and wireless data network services.

Use of simply designed distributed equipment supports deployment in an incremental fashion. Less costly distributed equipment is located by a group of potential subscribers. The group is likely to have some actual subscribers to the wireline or wireless services, but is also likely to have non-participating subscribers. When one or more non-participating subscribers elect to obtain services, the distributed equipment would already be appropriately located to service them. The distributed equipment is suitably less costly and can be deployed in advance of a customer's actual subscription.

A deployment of equipment for providing wireline or wireless data network services consisting of common equipment configured for a group of current subscribers and distributed equipment configured for a bigger group of potential subscribers.

The data network services are wireline for use on a wired connection to a subscriber.

The data network services are wireless for use on radio connection to a subscriber.

The data network services are a combination of both wired and wireless.

The data network service is comprised of protocol and modulation processing.

The common equipment configured for a group of current subscribers consists of centrally located processors.

The number of centrally located processors in common equipment configured for a group of current subscribers is approximately proportionate to the number of current subscribers.

The number of centrally located processors in common equipment configured for a group of current subscribers is based on the number of current subscribers.

The number of centrally located processors in common equipment configured for a group of current subscribers is based on the number of current subscribers and their subscribed service level.

The number of centrally located processors in common equipment configured for a group of current subscribers is based on processing load required to support the current subscribers.

The distributed equipment configured for a group of potential subscribers would include a signal driver for each subscriber line.

The distributed equipment configured for a group of potential subscribers would include a G.fast analog front end for each subscriber line.

The distributed equipment configured for a group of potential subscribers would include a DSL analog front end for each subscriber line.

The distributed equipment configured for a group of potential subscribers would include an RF head-end.

The distributed equipment would provide both wireline and wireless data network services.

The distributed equipment comprises a head-end device to drive signals onto each subscriber line.

The distributed equipment comprises a multiplicity of head-end devices to drive signals onto multiple subscriber lines.

The distributed equipment comprises a head-end device to receive signals from each subscriber line.

The distributed equipment comprises a multiplicity of head-end devices to receive signals from multiple subscriber lines.

The common equipment would provide wireline data network services.

The common equipment would provide wireless data network services.

The common equipment would provide both wireline and wireless data network services.

The common and distributed equipment would provide wireline data network services.

The common and distributed equipment would provide wireless data network services.

The common and distributed equipment would provide both wireline and wireless data network services.

### 4. Bandwidth Control/Customer Subscription Level

Use of G.fast DSL modems in a mixed configuration with other ADSL and VDSL modems is unlikely. VDSL can drive longer subscriber lines but also uses high signal levels. Cross talk interference would be considerably worse under those conditions. “Vectoring” was developed to address cross talk in VDSL but is generally not widely deployed. G.fast on the other hand requires the use of vectoring and the uncompensatable cross talk with VDSL would be greatly limiting the speed potential of G.fast.

The most successful implementations of G.fast would be in a homogeneous environment. Subscribers for lower bandwidth connections could easily use G.fast but with limited data rates. (AT&T U-verse service is based on DSL technology and is un-specific as to which DSL modem a subscriber is utilizing. AT&T is likely deploying VDSL modems to those customers which have limited data requirements which would be well matched by ADSL modems. Use of homogenous DSL modems simplifies operations quite a bit for a service provider such as AT&T.)

The distributed G.fast is also well suited for supporting varying customer subscription levels. There are several degrees of freedom that may be exercised. These include without limitation using constellations with fewer symbols (ie. smaller constellations), using fewer frequency bands and skipping frequency bands. Independently one may also adjust the upstream/downstream/idle allocation. Also knowing that only lower date rates are necessary, lower power level may be used with any approach.

One of the main reasons of exploiting the partial FFT/skipping samples method is to reduce the bandwidth between the common equipment and the distributed endpoints. Simply using the upstream/downstream controls for lower percentage times for lower bandwidth situations does not address peak demand on bandwidth. During the small time that all the lines are being driven, samples for each line at full speed are required. With the FFT subset/skipping samples method, we skip three out of four samples when only a quarter bandwidth is needed. And for what may be a typical subscription mix, this would keep the bandwidth under 10 Gb. It may be greater as more of the lines are subscribed as full speed G.fast, but then the extra expense of 20/30 Gb Ethernet or whatever incremental speed is justified.

Both static and dynamic data usage customer subscription levels can be supported by the methods described. Static subscription levels are based on the customer's purchased allotment of data throughput speed. Dynamic subscription level is based on the customer's current demands for data transfers. Commonly this would less that the static subscription and would be representative of low network usage periods such as when people are at work or school or when they are asleep. Dynamic subscription level may also be greater in case of a provider offering services such as movies on demand and not counting the movie's data transfer requirements against a static subscription.

The attached program shows some of the experiments for reducing bandwidth requirements. In a distributed G.fast implementation, the analog samples for each driven subscriber line need to be delivered to the DAC (digital to analog convertor) at the AFE. We have recognized that with certain bandwidth reduction methods, we can reduce the data communications between the G.fast server and the distributed G.fast AFE.

The basic idea of our techniques is to send fewer samples to a subscriber line. The full bandwidth requires samples at 106 MHz. If a reduced data rate is required, half or quarter of the full spectrum may be used. (Actually preferentially using lower spectrum can be desirable as often there is less cross talk at lower frequencies.)

One of our techniques (implemented in the source code by the SIMPLE_SKIP_SAMPLE option), simply sends every other sample for a bandwidth and has the AFE insert zeros for the skipped samples. Mathematically this is a “perfect” way to fill the sample stream. The FFT operation produces the exact constellations in the low frequency spectrum. (The upper spectrum in a half bandwidth implementation with zero stuffed samples is the complex conjugate of the lower spectrum. The upper ¾ of the spectrum for a quarter bandwidth implementation is replicated and conjugated.)

If there is a disadvantage of this technique it is the transmitted power level of the signal. Since only half or quarter of the samples are non-zero, the power level is comparably reduced.

Replicating the samples would change the spectrum significantly; the intervening samples must be zeroed. The signal will have potentially a higher peak-to-average (PAR) ratio so boosting the gain may exceed maximum signal levels and cause distortion. Additionally higher transmitted signal levels will also cause greater crosstalk due to linear and non-linear effects of the adjacent subscriber lines. This will need more investigation but since this reduced spectrum bandwidth technique is to mimic service levels associated with VDSL and ADSL technology, even with the lower power, the reduction should be effective.

An alternate technique to implement bandwidth reduction is to use a sample interpolation process to synthesize the skipped samples from every other or every fourth sample may be used. The interpolation does not need to be perfect. It only needs to be good enough. And the interpolation may produce a small signal gain to offset signal bleed over into other frequency bins. Our example code uses an interpolation of four samples (two behind and two ahead) to create the value for a skipped sample. With a little extra gain, this nearly perfectly recreates the transmitted frequency constellation data.

Essentially these techniques create aliases of a portion of specta (which would normally not be aliased because of a higher sample rate) that can then be either exploited or ignored. This can be done in both upstream and downstream directions for any spectral based modulation which uses IFFT and FFT operations.

A system for providing wireline or wireless data network services consists of assignable common equipment, a communications link and dedicated distributed equipment, implements a method of adapting to a subscriber's data usage requirement.

A system for providing wireline or wireless data network services consists of assignable common equipment, a communications link and dedicated distributed equipment, implements a method of adapting to a subscriber's data usage requirement whereby proportionate signal bandwidth is allocated and processed.

A method of adapting to a subscriber's data usage requirement in a distributed communications system performing wireline or wireless data network services consists of assignable common processing equipment, a communications link and dedicated distributed equipment.

Adapting to a subscriber′ data usage requirement allocates and processes proportionate signal bandwidth.

The data network services are wireline for use on wired connections to the subscriber.

The data network services are wireless for use on radio connections to the subscriber.

The data network services are a combination of both wired and wireless.

The data network service performed for a subscriber is comprised of protocol and modulation processing.

The subscriber's data usage requirement is statically determined based on their subscription.

The subscriber's data usage requirement is dynamically determined based on network usage.

The data network service modulation performed for a subscriber modulates a specified band of spectra.

The data network service modulation uses an inverse fast Fourier transform (IFFT) to transform a signal into real-time sample domain.

The data network service modulation uses a fast Fourier transform (FFT) to transform real-time samples into an internal signal domain.

The data network service modulation adapts to a subscriber's data usage requirement by filling a portion of modulated carriers in an inverse fast Fourier transform (IFFT) modulated symbol.

The data network service modulation adapts to a subscriber's data usage requirement by filling a portion of an inverse fast Fourier transform (IFFT) used to transform a modulated signal into real-time sample domain.

The data network service modulation adapts to a subscriber's data usage requirement by using a subset of real-time samples.

The data network service modulation adapts to a subscriber's data usage requirement by filling a portion of an inverse fast Fourier transform (IFFT) used to transform a modulated signal into real-time sample domain and then using a subset of real-time samples.

The data network service modulation adapts to a subscriber's data usage requirement by using a smaller inverse fast Fourier transform (IFFT) used to transform a modulated signal into real-time sample domain.

The data network service modulation adapts to a subscriber's data usage requirement by using a smaller inverse fast Fourier transform (IFFT) used to transform a modulated signal into a smaller set of real-time samples (relative to an original full set of samples resulting from using of a full-sized IFFT).

The data network service modulation compensates for a smaller number of real-time samples by filling in skipped real-time samples.

The data network service modulation compensates for a smaller number of real-time samples by filling in skipped real-time samples with values of zero.

The data network service modulation compensates for a smaller number of real-time samples by filling in skipped real-time samples with values interpolated between immediately adjacent samples.

The data network service modulation compensates for a smaller number of real-time samples by filling in skipped real-time samples with values interpolated from a limited number of adjacent samples.

The distributed equipment comprises a head-end device to drive signals onto each subscriber line.

The distributed equipment comprises a multiplicity of head-end devices to drive signals onto multiple subscriber lines.

The distributed equipment comprises a head-end device to receive signals from each subscriber line.

The distributed equipment comprises a multiplicity of head-end devices to receive signals from multiple subscriber lines.

It should be noted that a portion of the full bandwidth may be more directly exploited by transmitting the IFFT modulated symbol representation rather than the corresponding real-time samples. In this case, the distributed equipment performs the IFFT operation to generate the real-time samples. The IFFT modulated symbols representation can be limited to a portion of spectrum rather than the full bandwidth. As an example, half of the spectrum can be used by transmitting only the low frequency components of the bandwidth limited modulated symbol. A complementary alternative sends the high frequency components. Alternatively every other frequency carrier could be used for the partially modulated symbol and thereby only those carrier used would need to be sent. Inherent to the transmission of the partially modulated symbol is that any number of G.fast carriers can be used representing a variety of fractional usage from 0.1% to 99.9% (or more precisely fractionally from 1/4096 to 4095/4096 assuming that all 4096 carriers may be used).

In many ways, this approach to partial spectrum/bandwidth utilization can be considered more flexible. In terms of implementation, the partially filled modulated symbol after the vectoring operation would be sent according to compression parameters identifying the portion of the used spectrum. The compression parameters could be conveyed along with the used components of the partially filled modulated symbol or it could be sent in a separate setup or configuration message.

The data network service modulation adapts to subscribers' data usage requirements by sending the filled portion of the modulated carriers in an inverse fast Fourier transform (IFFT) modulated symbol to the distributed equipment.

The distributed equipment compensates for a smaller number of modulated carriers in an inverse fast Fourier transform (IFFT) modulated symbol by filling unspecified carriers with filler values.

The filler value used to fill an unspecified carrier may be zero representing an unused carrier.

The filler value used to fill an unspecified carrier may be constant representing a pilot tone carrier.

The filler value used to fill an unspecified carrier may be random representing a carrier that is not used to convey any meaningful information.

The distributed equipment performs an inverse fast Fourier transform (IFFT) process to generate real-time samples.

The distributed equipment comprises a head-end device to drive signals onto each subscriber line.

### 5. Remotely Creating Cyclic Prefix/Suffix

As described infra, the cyclic prefix (for reduction of ISI) and suffix (for implementation of windowing for control of spectral shaping) relies on a repetition of IFFT symbol samples. The transmission of samples to be sent to each line in a vector group of lines can be optimized in a preferred embodiment. (All lines in the vector group are to use the same size cyclic prefix, Lcp.)

In a preferred embodiment, a server may prepare the sample stream to the head-end with the cyclic prefix pulled forward. In particular it sends the last Lcp symbol samples first in time order to the head-end followed by the remaining symbol samples. In a cooperative fashion, the head-end then saves the first Lcp samples for playout after the remaining symbol samples are output to the line. Playout is the process for driving signals onto the subscriber line.

Also in a preferred embodiment, the head-end would save the β samples from the start of a symbol to be used as the cyclic suffix. These samples would be added to the matching β samples of the next symbol's cyclic prefix.

The implication of these procedures is to 1) deliver the samples in the order that they would be used for rendering the symbol onto the line and 2) to reduce the bandwidth required for the communications between the server to head-end device.

The setting of Lcp (for the entire vectoring group) and β (for each individual line) can be communicated a number of ways between the server and the head-end device. This can be done in a configuration message as one means of implementation. Alternatively either one or both may be communicated by augmentation of the sample loading tables proceeding sample values for each line. This is further described in the next sections.

A system for providing wireline or wireless data network services consists of common equipment, a communications link and distributed equipment, implements a method for reducing intersymbol interference (ISI) between successive IFFT modulated signal segments which avoids redundant transmission of samples.

A system for providing wireline or wireless data network services consists of common equipment, a communications link and distributed equipment, implements a method for reducing intersymbol interference (ISI) between successive IFFT modulated signal segments which avoids redundant transmission of samples for a cyclic prefix.

A system for providing wireline or wireless data network services consists of common equipment, a communications link and distributed equipment, implements a method for reducing intersymbol interference (ISI) between successive IFFT modulated signal segments which avoids transmission of samples for a cyclic suffix.

A system implementing a method for reducing intersymbol interference (ISI) between successive IFFT modulated signal segments consists of common equipment, a communications link and distributed equipment communicating with a subscriber, and transmission of samples between common and distributed equipment.

The method for reducing intersymbol interference (ISI) between successive IFFT modulated signal segments which avoids redundant transmission of samples.

The method for reducing intersymbol interference (ISI) between successive IFFT modulated signal segments which avoids redundant transmission of samples for a cyclic prefix.

The method for reducing intersymbol interference (ISI) between successive IFFT modulated signal segments which avoids transmission of samples for a cyclic suffix.

The data network services are wireline for use on a wired connection to a subscriber.

The data network services are wireless for use on radio connection to a subscriber.

The data network services are a combination of both wired and wireless.

The data network service is comprised of protocol and modulation processing.

The distributed equipment comprises a head-end device to drive signals onto each subscriber line.

The distributed equipment comprises a multiplicity of head-end devices to drive signals onto multiple subscriber lines.

The distributed equipment comprises a head-end device to receive signals from each subscriber line.

The distributed equipment comprises a multiplicity of head-end devices to receive signals from multiple subscriber lines.

The data network service modulation uses an inverse fast Fourier transform (IFFT) to transform a signal into the real-time sample domain.

The method for reducing intersymbol interference (ISI) between successive IFFT modulated signal segments communicates the cyclic prefix (Lcp) size to the distributed equipment.

The method for reducing intersymbol interference (ISI) between successive IFFT modulated signal segments communicates the cyclic suffix (β) size to the distributed equipment.

The distributed equipment remembers the cyclic prefix (Lcp) size and uses this to determine which real-time samples from an IFFT modulated signal segment need to be sent to a subscriber as the cyclic prefix.

The distributed equipment will extract the LCP cyclic prefix samples from real-time samples of an IFFT modulated signal segment and sends extracted samples to a subscriber as the cyclic prefix.

The distributed equipment remembers the cyclic suffix (β) size and uses this to determine which real-time samples from an IFFT modulated signal segment need to be sent to a subscriber as the cyclic suffix.

The distributed equipment will combine the β cyclic suffix samples from the real-time samples of two consecutive IFFT modulated signal segments and sends the combined samples to a subscriber as the cyclic suffix.

### 6. Link Latency and Sample Loading Tables

The sample transmission between the G.fast server and the distributed G.fast AFE will be bidirectional and likely implemented over fiber optic media. At the standard G.fast implementation which uses a bandwidth of 106 MHz, the sample rate would be doubled to 212 MHz. At the optional bandwidth of 212 MHz, the sample rate would be 424 MHz. Sample bandwidth transmission can also be reduced by re-ordering the cyclic prefix/suffix samples prior to transmission and then replaying the prefix samples at the correct time. For a typical cyclic prefix of 320 samples, this would reduce bandwidth a factor of 320/(4096+320). (4096 is the number of real samples in from the IFFT symbol.)

As each sample would be approximately 12 bits and 8 to 16 lines would be serviced from a single G.fast AFE, the required data rate would be 24 to 48 GBytes/sec. The required data rate drops if only a fraction of the full bandwidth is required (as described in section 4) (as per Table 2). For a quarter of the 1 Gbps (125 MByte/sec) bandwidth (corresponding to a customer that is only subscribing to 30 MByte/sec service, the required data rate for 16 lines is 12 GBytes/sec and 8 lines is 6 GBytes/sec. Both of these are well within the available specs for optical data transmission. (The FCC has recently declared 25 Mbps service as minimum broadband service so this reduced rate using a fraction of the available bandwidth/spectrum is still substantially above minimal broadband.)

TABLE 2
Data Rate Requirements for Multiple DSLAM Lines.

| | | | | Bandwidth | Lines | |
|---|---|---|---|---|---|---|
| | FFT | FFT Rate | Sample | Used | per | Data Rate |
| | Size | (per sec.) | Size (bits) | (1 for full) | AFE | (Mbyte) |
| G.fast - L | 4096 | 480000 | 12 | 1 | 16 | 47185.92 |
| | | | | 0.5 | | 23592.96 |
| | | | | 0.25 | | 11796.48 |
| | | | | 0.125 | | 5898.24 |
| | | | | 1 | 8 | 23592.96 |
| | | | | 0.5 | | 11796.48 |
| | | | | 0.25 | | 5898.24 |
| G.fast - H | 8192 | 480000 | 12 | 1 | 16 | 94371.84 |
| | | | | 0.5 | | 47185.92 |
| | | | | 0.25 | | 23592.96 |
| | | | | 1 | 8 | 47185.92 |
| | | | | 0.5 | | 23592.96 |
| | | | | 0.25 | | 11796.48 |

In our preferred implementation, the data transmission uses Ethernet protocol at 10 GB or faster rates. With this Ethernet data rate a variety of subscriber data rates (as varied by bandwidth utilization) and active subscriber lines can be accommodated. If greater capacity is required, a faster optical Ethernet rate of 50 or 100 GB is either available or soon planned to be available. It should be noted that with a 100 GB Ethernet connection, the high rate of G.fast can be accommodated at the full configuration of 16 lines at full bandwidth. If properly anticipated, the only change required to boost the Ethernet data rate is to exchange the SFP optical transceiver module and the rest of the circuit would work the same (albeit at a higher rate within the Ethernet MAC/PHY).

In another preferred implementation, the data transmission uses GPON optical networking protocol. The bandwidth offerings are similar to optical Ethernet although the physical plant and optical modules tend to be generally more expensive.

Latency in the G.fast standard is a bit of a concern. G.fast uses a data link level error correction scheme whereby a G.fast DSL frame can be required for re-transmission (by lack of its acknowledgment). With the partitioning of the G.fast AFE from the G.fast server, the effect on latency can be pretty substantial. The sample exchange between the server and the G.fast AFE is preferably multiplexed in order to reduce delays due to buffering of sampled before playout on the AFE. In our preferred embodiment, the samples for each subscriber line are multiplexed for playout at the same time and then followed in sequence by the next set of subscriber line samples. When supporting 16 subscriber lines, there would be 16 samples (on for each line) and followed by another set of 16 samples (one for each line) to be played out one time period later.

If not all of the subscriber lines are active, less data can be sent by skipping the inactive line(s). This can be indicated by data (or control) indicating how to distribute the incoming network samples (from the G.fast server) to each of the supported lines (8 or 16 lines in our example). A simple scheme is considered best. We would suggest use of 16-bit data whereby each bit corresponds to the presence of samples for a corresponding subscriber line. Alternatively an array of data could be used to indicate the assignment of samples to a corresponding line. The length of such array would be variable. Either the 16-bit data or array of data could be conveyed in-band (such as within the start of the Ethernet data frame containing the associated samples) or conveyed out-of-band in a control message to the G.fast AFE device.

The bandwidth utilization can be similarly indicated on a per channel basis. As a quick review, when using half of the bandwidth, a non-zero sample is sent for every other time period. For a quarter of the bandwidth, a non-zero sample is sent for one out of four time periods. For the benefit of the following discussion, we will assume that a minimum partition of the bandwidth is one-eight. This could be represented by one of four settings such as:
11—One eight bandwidth—skip seven samples
10—One quarter bandwidth—skip three samples
01—One half bandwidth—skip one sample
00—Full bandwidth—no skipped samples

An alternative representation is to use multiple 16-bit data words to convey the sample distribution pattern to each of the subscriber lines. A total of eight 16-bit words would be needed to convey the four bandwidth partitions. In a preferred embodiment, a value of 1 would indicate the presence of a sample for a corresponding subscriber line for that time period. The next 16-bit word would be used for distributing samples to subscriber lines for the next time period. When the eight 16-bit word is used, the process repeat with the first 16-bit word.

As an example, subscriber lines 1, 2, 4 and 8 are used in full, half, quarter and eight bandwidth modes. Subscriber lines 3, 5, 6, 7, 9, 10, 11, 12, 13, 14, 15 and 16 are not in use. Bit 0 (rightmost) is the least significant bit (LSB) of the 16-bit word and it is designated to correspond to line 1.
Word 1—0000 0000 1000 1011
Word 2—0000 0000 0000 0001
Word 3—0000 0000 0000 0011
Word 4—0000 0000 0000 0001
Word 5—0000 0000 0000 1011
Word 6—0000 0000 0000 0001
Word 7—0000 0000 0000 0011
Word 8—0000 0000 0000 0001

After the samples are distributed in time order according to the eight word pattern, the first word is used again. If a smaller bandwidth partition is required, then the number of words would be doubled for each reduction by two. If the quarter bandwidth was deemed to be the smallest bandwidth reduction, then only four words would be required.

In our preferred embodiment, this four or eight word pattern would be prefixed to the samples in each Ethernet packet of samples. This would allow for precise control of sample distribution especially when a bandwidth change is dynamic. Dynamic reductions are anticipated when network activity ceases such as when an IP video ceases or perhaps is paused. An increase of course corresponds to a demand for more bandwidth.

Sample rate/bandwidth reduction in the upstream direction of subscriber to network (where the G.fast AFE samples the analog signal) can be similarly handled. A reduction in the apparent sample rate can be supported using similar conventions. Additional processing in the AFE may be needed to ensure signal quality. This is discussed in the following section. The control of the upstream sample loading can be similarly conveyed using a multiplicity of 16-bit words. This can be controlled by the G.fast server out-of-band through a control channel or by prefixing a set of 16-bit words to the downstream sample packet for use in controlling the next 16-bit packet of upstream samples.

It should also be noted that the cyclic prefix/suffix replay is only a function for downstream samples. In the upstream direction, the entire DMT symbol (IFFT samples and cyclic prefix/suffix) would need to be digitized and sent to the G.fast server for its processing.

Since the cyclic prefix and suffix can be of varying size (the size of the cyclic prefix is to be common to all liens in a subscriber group/bundle using the same vectoring), appears to be

It should be noted that bandwidth reduction by sending the filled portion of the modulated carriers in an inverse fast Fourier transform (IFFT) modulated symbol to the distributed equipment can be handled using similar tables. In this operating mode a specified number of modulated carriers would be transported along with a mapping to their position in an inverse fast Fourier transform (IFFT) modulated symbol where the output of the IFFT is a set of real-time samples to be output through the AFE.

### 7. Maximum Delay Analysis

The delay analysis for a preferred embodiment uses the following assumptions:
The impulse noise maximum allowable retransmission delay is the worst case specification to meet
Tret must be less that 400 μs per G.9701 section 9.8.
   Tret is measured from the end of ACK reception at the DPU receiver to the start of DTU retransmission at the DPU transmitter
Using “G.9701(12/2014)”
Ethernet transport all at 10 Gbps
SAToP to transport sampled data
   Ethernet frames prioritized at PCP priority 5 and all switches honor priority
   No packets dropped due to congestion

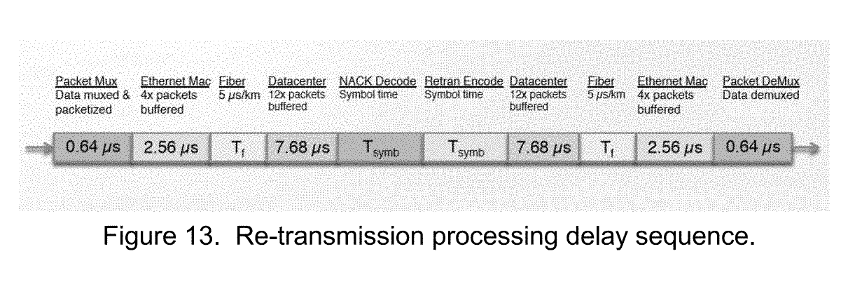

G.9701 Re transmission requirements are described in detail in ITU G.9701 Recommendation which has been incorporated by reference. In particular FIG. 9 shows the re-transmission time Tret which is less than 400 usec. The re-transmission path processing is summarized in FIG. 13 and shows the expected timing for a preferred embodiment that partitions the G.fast implementation between common equipment and distributed head ends connected by a rout-able optical network. The computed Tret from this implementation is now:

Tret=2*(10.88+Tsymb+Tf)=21.76μs+2Tsymb+2Tf

Some of the relevant details are:
Start time is reception of end of ACK at DTU receiver
End time is start of retransmitted data at DTU
Datacenter delay is:
   4× buffered packets in edge switch
   4× buffered packets in TOR switch
   4× buffered packets in server blade MAC
Packet Mux:
   32×12 bit samples per packet
   16 Channels: 768 payload bytes
   800 bytes including overhead

From this we expect:
Tret=21.76 μs+2Tsymb+2Tf
Assuming a conventional system will also have 2Tsymb of processing delay. The extra delay for this embodiment is: 21.76 μs+2Tf
Speed of light delay
   Delay over single mode telecom fiber: 5 μs/km, 8 μs/mile
   Servers in CO: 2Tf=45 μs
   800 bytes including overhead
Total Trec Examples
   63.42+2Tf (for Tsymb=20.83 μs)
   Delay over fiber: 5 μs/km, 8 μs/mile
   109 μs (for 15,000 ft of fiber)
   263 μs (for 20 km of fiber)

### 8. Early Implementation

This section describes an early implementation of a preferred embodiment:
Demonstration System
   1 Gbps over 70M copper
   Fiber backhaul to server
   Single subscriber
G.Fast Physical Layer per standard
Virtualized server access application
Hardware based on FPGA eval board

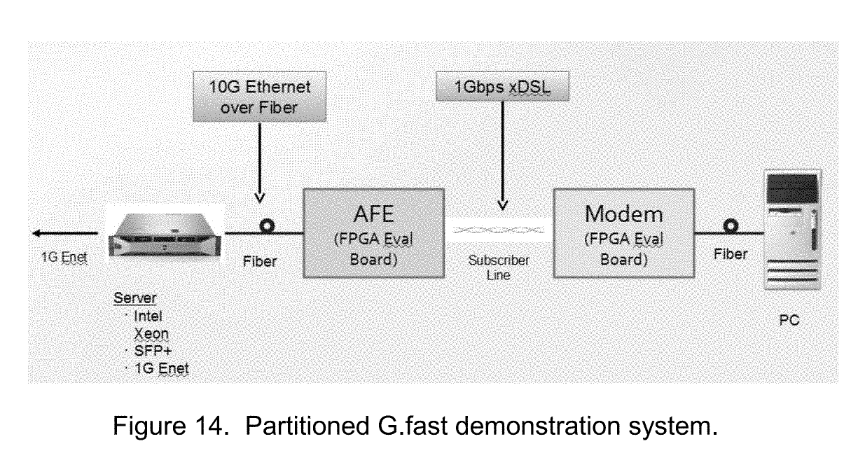

FIG. 14 shows a representation of a partitioned G.fast demonstration system. The Server on the left in FIG. 14 is used to represent the common equipment (which is comprised of a general purpose x86 Intel server). It is connected to the head end (AFE) by a fiber optic Ethernet. In a more general configuration, the fiber optic Ethernet may be routed or switched as necessary to connect the common equipment to the geographically distributed head end equipment performing the subscriber line interface function using an AFE connected to each subscriber line. The PC on the right in FIG. 14 is used to implement/emulate the G.fast modem. Emulation was necessary as subscriber modems implementing G.fast were not readily or commercially available for use in this demonstration system.

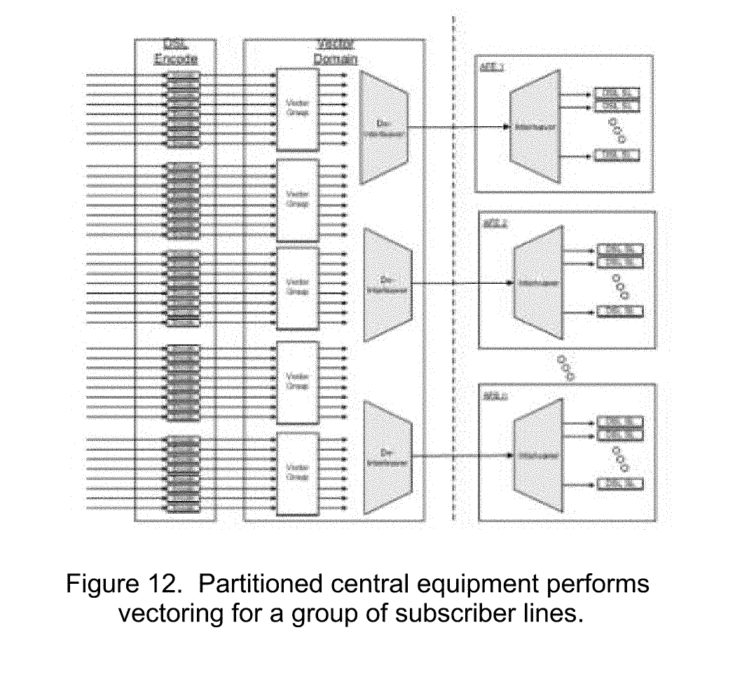

FIG. 12 is another diagram showing some of the processing performed in the common equipment (DSL encoding/decoding and vectoring) and the communication links to three head end equipment units whereby each head end services a group of subscriber lines. The DSL encoding/decoding may be performed by multiple general purpose processors while the vectoring operation would require encoded DSL samples to be exchanged or shared in order to compensate for the cross talk of subscriber lines in cable bundles (or binder as those in telephony terminology would recognize). In a preferred embodiment, the head end for a group of subscriber lines would likely all be in the same cable bundle.

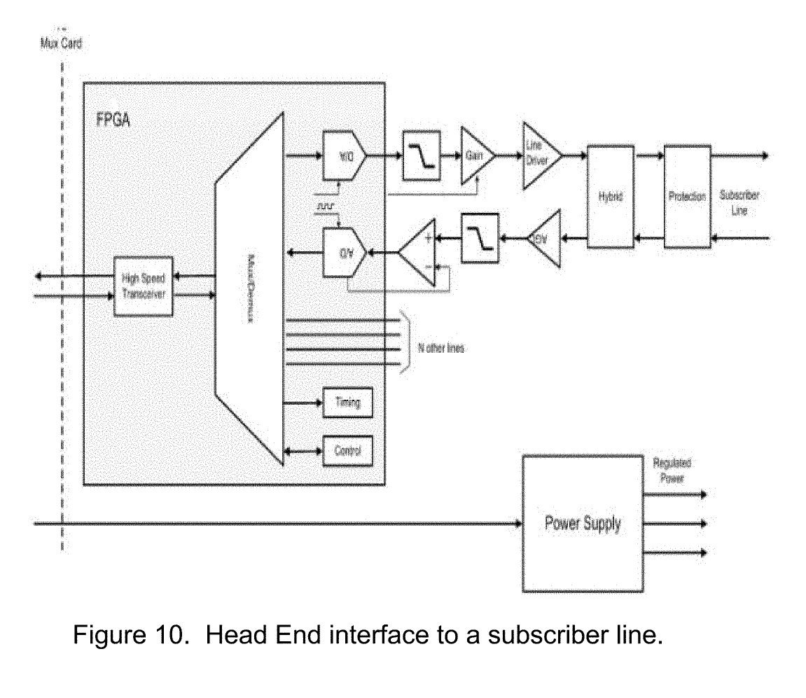

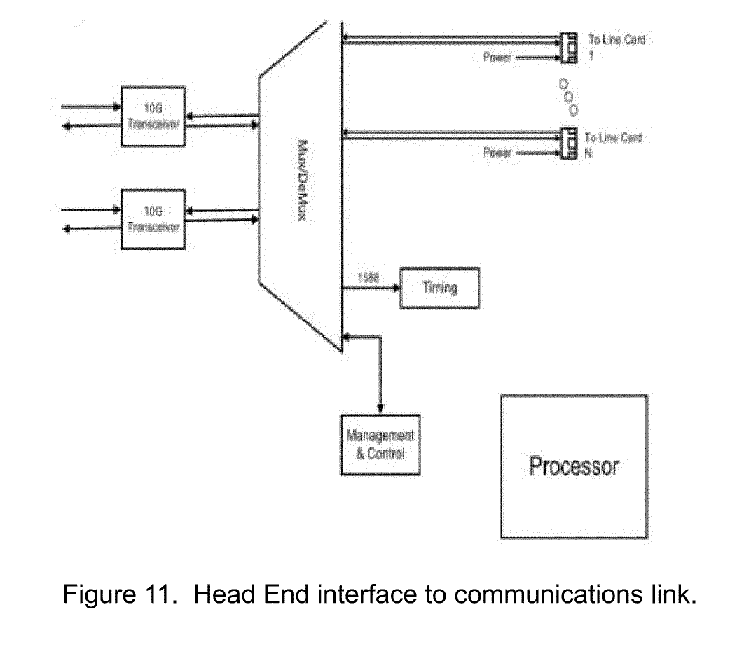

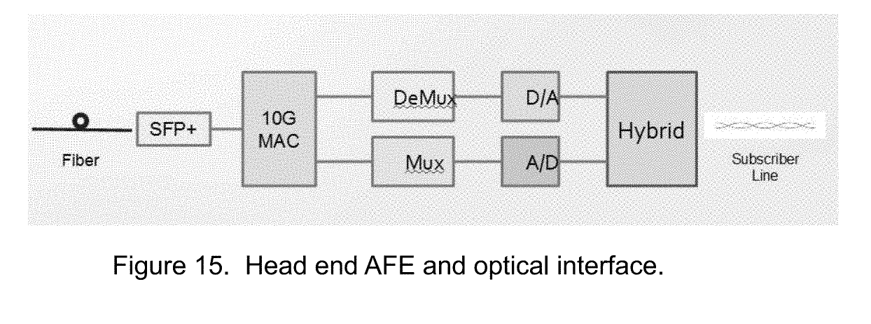

FIG. 15 show a head end configuration with an Analog Front End (AFE) (shown as the analog-digital and digital-to-analog convectors and the hybrid electronics) for connections to the subscriber line and and optical network connection to the server equipment. FIGS. 10 and 11 provide a more detail on head end equipment implementation and grouping to service multiple subscribers.

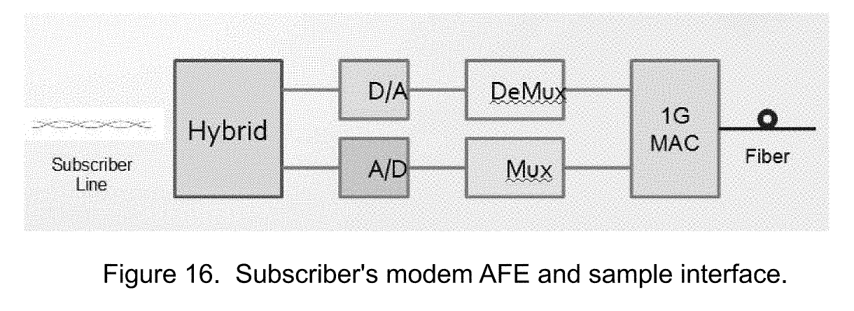

FIG. 16 shows the subscriber's modem's AFE (shown as the analog-digital and digital-to-analog convectors and the hybrid electronics) and connection to a PC to process samples using G.fast algorithms and protocols.

What we claim is:

1. A method of implementing a distributed communication system comprising:
common equipment using centrally located processors for performing data network services;
route-able communications link from common equipment to distributed equipment; and,
distributed equipment located near subscribers.

2. The method recited in claim 1 wherein said data network services are a combination of both wired and wireless.

3. The method recited in claim 1 wherein said data network service is comprised of protocol and modulation processing.

4. The method recited in claim 1 wherein said processors would be comprised of general purpose processors.

5. The method recited in claim 1 wherein said route-able communications link would be comprised of a fast packet network.

6. The method recited in claim 1 wherein said distributed equipment comprises a head-end device to drive signals onto each subscriber line.

7. The method recited in claim 1 wherein said distributed equipment would be used as an element to provide wireless data network services.

8. A method of adapting to a subscriber's data usage requirement in a distributed communications system performing wireline or wireless data network services comprising:
assignable common processing equipment;
communications link; and,
dedicated distributed equipment.

9. The method recited in claim 8 wherein said data network service performed for said subscriber is comprised of protocol and modulation processing.

10. The method recited in claim 9 wherein said data network service modulation performed for said subscriber modulates a specified band of spectra.

11. The method recited in claim 10 wherein said data network service modulation adapts to said subscriber's data usage requirement by filling a portion of modulated carriers in an inverse fast Fourier transform (IFFT) modulated symbol.

12. The method recited in claim 10 wherein said data network service modulation adapts to subscriber's data usage requirement by filling a portion of an inverse fast Fourier transform (IFFT) used to transform a modulated signal into real-time sample domain and then using a subset of real-time samples.

13. A method of reducing intersymbol interference (ISI) between between successive IFFT modulated signal segments for wireline or wireless data network services comprising:
common equipment;
communications link;
distributed equipment; and,
transmission of samples.

14. The method recited in claim 13 wherein said transmission of samples excludes samples for a cyclic suffix.

15. The method recited in claim 13 wherein said method for reducing intersymbol interference (ISI) between successive IFFT modulated signal segments communicates a cyclic prefix (Lcp) size to distributed equipment.

16. The method recited in claim 13 wherein said method for reducing intersymbol interference (ISI) between successive IFFT modulated signal segments communicates a cyclic suffix (β) size to distributed equipment.

17. The method recited in claim 13 wherein said distributed equipment remembers a cyclic prefix (Lcp) size and uses this to determine which real-time samples from an IFFT modulated signal segment need to be sent as a cyclic prefix.

18. The method recited in claim 13 wherein said distributed equipment will extract the LCP cyclic prefix samples from real-time samples of an IFFT modulated signal segment and sends extracted samples as a cyclic prefix.

19. The method recited in claim 13 wherein said distributed equipment remembers a cyclic suffix (β) size and uses this to determine which real-time samples from an IFFT modulated signal segment need to be sent as a cyclic suffix.

20. The method recited in claim 13 wherein said distributed equipment will combine the β cyclic suffix samples from the real-time samples of two consecutive IFFT modulated signal segments and sends the combined samples as a cyclic suffix
